(19) United States
(12) Patent Application Publication
(10) Pub. No.: US 2025/0316749 A1
(43) Pub. Date: Oct. 9, 2025

(54) Preparation And Application Of A Polymer-based Composite Solid Electrolyte With High Ionic Conductivity

(71) Applicant: Beijing University of Technology, Beijing (CN)

(72) Inventors: Haijun YU, Beijing (CN); Lingqiao WU, Beijing (CN)

(21) Appl. No.: 18/833,894

(22) PCT Filed: Oct. 31, 2023
(86) PCT No.: PCT/CN2023/128237

§ 371 Date: Jul. 27, 2024

(30) Foreign Application Priority Data
Jan. 1, 2023 (CN) 202310005768.7

(51) Int. Cl. H01M 10/056; H01M 4/131; H01M 4/134; H01M 4/1391; H01M 4/38; H01M 4/505; H01M 4/62; H01M 10/0525

(52) U.S. Cl. CPC H01M 10/056; H01M 4/131; H01M 4/134; H01M 4/1391; H01M 4/382; H01M 4/505; H01M 4/623; H01M 4/625; H01M 10/0525; H01M 2300/0071; H01M 2300/0082; H01M 2300/0091

(57) ABSTRACT

The invention discloses a preparation and application method of a high ionic conductivity polymer-based composite solid electrolyte, and belongs to the technical field of lithium-ion battery electrolytes. The organic-inorganic composite solid electrolyte is prepared by compounding a carbonate-based polymer, a conductive lithium salt, a porous support material, a functionalized silane coupling agent and an inorganic ion conductor material. The polycarbonate-based polymer electrolyte has high ionic conductivity, a wide electrochemical window and a high ion transference number; the functionalized silane coupling agent can form chemical bonds and interact with the polymer and the inorganic material to play a bridge role between the polymer and the inorganic filler, so that the ionic conductivity of the polymer electrolyte is improved, the electrochemical window of the polymer electrolyte is widened, the interface contact between the solid electrolyte and positive and negative electrodes is improved, and the electrochemical performance of the solid electrolyte is improved. Therefore, the charge-discharge performance of the lithium-ion battery is improved. The method is suitable for a lithium-ion solid-state battery of a high-voltage positive electrode material.

### TECHNICAL FIELD

The invention relates to a solid electrolyte for lithium-ion batteries, in particular to a preparation method and application of a composite solid electrolyte for building a bridge between a polymer and an inorganic material which belonging to the technical field of lithium ion battery electrolytes.

### BACKGROUND

Lithium-ion batteries are widely used in 3C consumer electronics, electric vehicles and energy storage fields due to their many advantages such as high energy density, long cycle life and no memory effect. At present, most commercial lithium-ion batteries use conventional organic liquid electrolytes, which have huge safety issues such as volatility, flammability, and explosion, which seriously hinder the wider application of lithium-ion batteries. Therefore, using solid electrolytes instead of traditional organic electrolytes is one of the effective ways to solve the above-mentioned safety problems of lithium-ion batteries. At the same time, solid-state electrolytes also have the advantages of high ionic conductivity, wide electrochemical window, wide operating temperature, and can be arbitrarily tailored or changed.

Solid electrolytes mainly include inorganic solid electrolytes, polymer solid electrolytes, and organic-inorganic composite electrolytes. Inorganic solid electrolytes have the advantages of high mechanical strength and high room temperature ionic conductivity; but they also face huge problems, such as high density of electrolyte materials, high material rigidity, poor interface compatibility, and high interface impedance with electrodes. Organic polymer electrolytes have the advantages of good compatibility with lithium metal, simple preparation process, good flexibility and adjustable shape and size, but their ionic conductivity is low. Therefore, the use of a single inorganic solid electrolyte or polymer electrolyte is difficult to meet the actual needs of current lithium batteries.

Polymer-based organic-inorganic composite electrolytes combine the advantages of organic and inorganic materials, and have greatly improved ionic conductivity, electrochemical window, mechanical strength, etc., solving problems that cannot be solved by a single component. Chinese Patent CN111435757B discloses a composite polymer electrolyte, a preparation method thereof, and a lithium-ion battery. The mass distribution of the inorganic lithium-conducting material in the composite polymer electrolyte along the thickness direction shows a decreasing or increasing change, which can improve the lithium-ion concentration difference at each interface, thereby improving lithium-ion transmission to a certain extent. However, its ionic conductivity and electrochemical window still cannot match high-voltage positive electrode materials. Chinese Patent CN110380114B provides an organic-inorganic composite solid electrolyte and a preparation method and application thereof, wherein the method can improve the agglomeration problem of inorganic conductor materials, thereby improving ionic conductivity and inhibiting lithium dendrites. However, on the one hand, the ionic conductivity of this patent is not high enough, and on the other hand, the ether polymer used is difficult to match the use of high-voltage positive electrode materials.

Therefore, in view of the problems existing in the prior art, it is necessary to provide a new organic-inorganic composite solid electrolyte membrane, which has a simple preparation method and can withstand high voltage while ensuring high ionic conductivity.

### SUMMARY

The purpose of the present invention is to provide a method for preparing a polycarbonate-based organic-inorganic composite solid electrolyte and its application in the field of lithium-ion batteries. In the polymer-based composite solid electrolyte provided by the present invention, chemical bonds are formed between the functionalized coupling agent and the inorganic and organic materials, so that the inorganic solid electrolyte and the polymer are connected using the coupling agent, thereby improving their ionic conductivity and electrochemical window, and showing excellent cycle stability when matched with high-voltage positive electrode materials.

To achieve the purpose of the invention, the technical solution of the present invention is:
The present invention provides a high ion conductivity polymer-based composite solid electrolyte, the raw materials of which include the following components: carbonate-based polymer, inorganic ion conductor, initiator or catalyst, lithium salt and silane coupling agent;
The mass fraction of the carbonate-based polymer in the mixture is 10%-96%, the mass fraction of the functionalized silane coupling agent in the mixture is 1%-50%, the mass fraction of the conductive lithium salt in the mixture is 1%-50%, the mass fraction of the inorganic ion conductor in the mixture is 1%-50%, and the mass fraction of the initiator or catalyst in the mixture is 1%-10%.

The carbonate-based polymer is one or more selected from the group consisting of polycarbonate, polyvinyl carbonate, polyvinyl ethylene carbonate, polyallyl methyl carbonate, polyvinylene carbonate, polyfluoroethylene carbonate and the like. The C═O double bond in the carbonate group can form a chemical interaction with the active H on the silane coupling agent.

The inorganic lithium-ion conductor material is an inorganic solid lithium-ion electrolyte, and the material contains one or a combination of at least two of hydroxyl, carboxyl or sulfur groups.

The silane coupling agent has a structure as shown in Formula I:

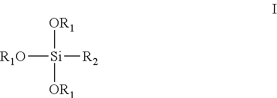

Wherein R₁ is selected from any one of methyl, ethyl, and propyl; R₂ is selected from any one of aminopropyl, aminoethyl, mercapto, or urea.

The selected conductive lithium salt is one or more of the following: lithium hexafluorophosphate (LiPF₆), lithium perchlorate LiClO₄), lithium bis(LiTFSI)imide (LiTFSI), and bis(trifluoromethanesulfonyl)methyl lithium [LiC(SO₂CF₃)₃].

The initiator or catalyst is one of the following: azobisisobutyronitrile (AIBN), azobisisoheptanenitrile (ABVN), dibutyltin bis(acetylacetonate), dibutyltin dilaurate, dimethyl azobisisobutyrate (AIBME), benzoyl peroxide (BPO), platinum water (Pt).

The method for preparing the high ionic conductivity organic-inorganic composite solid electrolyte comprising the following steps:
(1) taking an inorganic ion conductor material, a functionalized silane coupling agent, and an organic solvent raw material, stirring and mixing them uniformly, heating and hydrolyzing them at 30° C.-80° C. (reagents and trace water in the air are sufficient) for 12-24 hours, and then removing the solvent in a vacuum drying oven at 80° C.-120° C. to prepare a silanized inorganic ion conductor material;
(2) uniformly stirring the silanized inorganic ion conductor material, carbonate-based polymer, conductive lithium salt, and organic solvent obtained in step (1); adding an initiator or a catalyst and uniformly stirring to form an electrolyte mixture; coating or immersing the electrolyte mixture into a polytetrafluoroethylene mold containing a porous support material, and heating and curing at 60° C.-120° C. for 4-12 hours to form a film;
The organic solvent selected in the above steps (1) and (2) is one or more of the following: N-methylpyrrolidone (NMP), ethylene carbonate, propylene carbonate, butylene carbonate, dimethyl carbonate, ethylene carbonate, ethyl methyl carbonate, γ-butyrolactone, tetrahydrofuran, 2-methyltetrahydrofuran, acetonitrile, 1,2-dimethoxyethane, tetraethylene glycol dimethyl ether, triethylene glycol dimethyl ether, diethylene glycol dimethyl ether, and dimethyl sulfoxide.

The porous supporting material is one or more of cellulose non-woven fabric, polyethylene non-woven fabric, polypropylene non-woven fabric, glass fiber non-woven fabric, and polytetrafluoroethylene non-woven fabric. Preferred supporting materials can improve the mechanical properties of polymer-based composite electrolytes.

Taking an inorganic ion conductor with a hydroxyl group (X—OH) as an example, R₂ is selected from any one of aminopropyl, aminoethyl, mercapto or urea, and the chemical bond formation process is as follows:

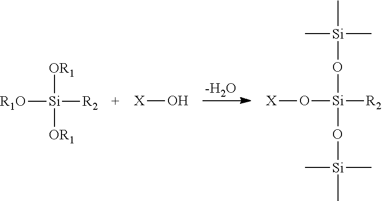

Coupling agents serve as bridges between inorganic and organic matter to provide additional ion transport channels and reduce the interface resistance between organic and inorganic substances. They utilize intermolecular interactions and stable chemical bonds to improve the electrochemical stability of polymer-based composite electrolytes. Intermolecular interactions include positive vacancy effects, dipole-dipole interactions, and hydrogen bond interactions.

Taking the carbonate-based polymer (Y—C(═O)—O—) and the R₂ group as an aminopropyl group as an example, the above-mentioned intermolecular chemical reaction formation process is as follows:

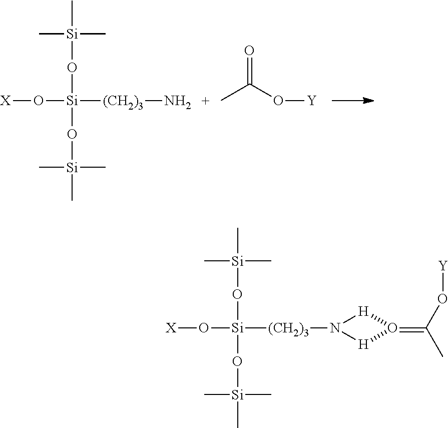

The invention provides application of the high ion conductivity polymer-based composite solid electrolyte in lithium ion batteries.

A solid-state lithium-ion battery comprising the above-mentioned high ion conductivity polymer-based composite solid electrolyte, comprises a positive electrode, a negative electrode and the above-mentioned composite solid electrolyte placed between the positive electrode and the negative electrode and having the functions of both a separator and an electrolyte.

The positive electrode active material of the lithium-ion battery is one or more of lithium cobalt oxide (LiCoO₂), lithium nickel oxide LiNiO₂), lithium ion lithium fluorophosphate, lithium manganese oxide, lithium manganese oxide, lithium nickel manganese oxide, lithium rich materials (LLOs), lithium iron manganese phosphate, lithium nickel cobalt aluminum oxide (NCA), lithium nickel cobalt manganese oxide, lithium iron phosphate (LiFeO₄), and lithium vanadium phosphate (Li₃V₂(PO₄)₃); the negative electrode active material is one or more of metallic lithium, metallic lithium alloy, graphite, hard carbon, lithium metal nitride, antimony oxide, carbon germanium composite material, carbon silicon composite material, lithium titanate, and lithium titanium oxide.

The preparation of the positive electrode of a lithium-ion battery includes the following steps: grinding and mixing a positive electrode active material accounting for 50%-90% by mass and a conductive agent acetylene black accounting for 5%-30% by mass; adding polyvinylidene fluoride (PVDF) accounting for 1%-15% by mass, 1%-15% electrolyte mixed solution and 1-methyl-2-pyrrolidone (NMP) to grind and mix, and 1-methyl-2-pyrrolidone (NMP) is used to adjust the viscosity; coating on the surface of aluminum foil and drying; metallic lithium and metallic lithium alloy can be directly used as the corresponding negative electrode. The preparation of other negative electrodes includes the following steps: grinding and mixing a negative electrode active material accounting for 45%-80% by mass and a conductive agent acetylene black accounting for 5%-30% by mass; adding polyvinylidene fluoride (PVDF) accounting for 5%-25% by mass and 1-methyl-2-pyrrolidone (NMP) to grind and mix, and 1-methyl-2-pyrrolidone (NMP) is used to adjust the viscosity; coating on the surface of copper foil and drying.

The above-mentioned electrolyte mixture is preferably an electrolyte mixture formed during the preparation process of the above-mentioned high ionic conductivity organic-inorganic composite solid electrolyte.

Lithium-ion battery assembly includes button cells and soft pack cells.

A chemical bond is formed between the coupling agent and the inorganic ion conductor material, and an intermolecular interaction is formed between the coupling agent and the carbonate-based polymer to reduce the interface resistance between the organic and inorganic. The coupling agent acts as a bridge between inorganic and organic matter to provide an additional ion transmission channel; the intermolecular interaction includes one or more of the intermolecular interactions such as the formation of chemical bonds, hydrogen bond interactions, dipole-dipole interactions, and positive vacancy effects. The formation of a stable chemical bond between the inorganic material and the coupling agent improves the problem of large interface impedance between the polymer and the inorganic conductor material, provides additional ion channels, greatly improves the ionic conductivity (room temperature ionic conductivity is 3.1×10⁻³ S cm⁻¹), and has a wider electrochemical stability window (5.3 V/vs. Li⁺/Li).

The innovation and practicality of the present invention are:
1. The polycarbonate-based polymer has high ionic conductivity, and the composite solid electrolyte has excellent ion transport capability and thermal stability.
2. The present invention adopts a two-step method to effectively realize the bridge construction between the polymer chain and the inorganic material, reduce the interface resistance between the polymer phase and the inorganic phase, improve the interface compatibility, and improve the overall ion conductivity; in addition, the coupling agent forms a stable chemical bond with the inorganic ion conductor and forms an intermolecular interaction with the C═O of the polymer chain, which can increase the ion migration number and the electrochemical window, significantly improve the compatibility of the electrolyte and the electrode interface, and thus improve the charge and discharge performance.
3. The polymer-based organic-inorganic composite solid electrolyte provided by the present invention has an ion conductivity of up to 3.1×10⁻³ S cm⁻¹, a lithium ion migration number of more than 0.64, and an electrochemical window of more than 5.3V. The assembled solid-state lithium battery exhibits a Coulombic efficiency of up to 98% and excellent cycle stability at high voltage.

### DESCRIPTION OF THE DRAWINGS

FIG. 1 is an LSV diagram of embodiments 1 and 5 for preparing high ionic conductivity polymer-based composite solid electrolytes.

FIG. 2 is a CV curve of the lithium-ion battery in embodiment 5 of preparing a high ionic conductivity polymer-based composite solid-state lithium-ion battery.

FIG. 3 is a charge and discharge curve of a solid-state lithium-ion battery assembled based on the electrolyte in embodiment 5 and a lithium-rich positive electrode material.

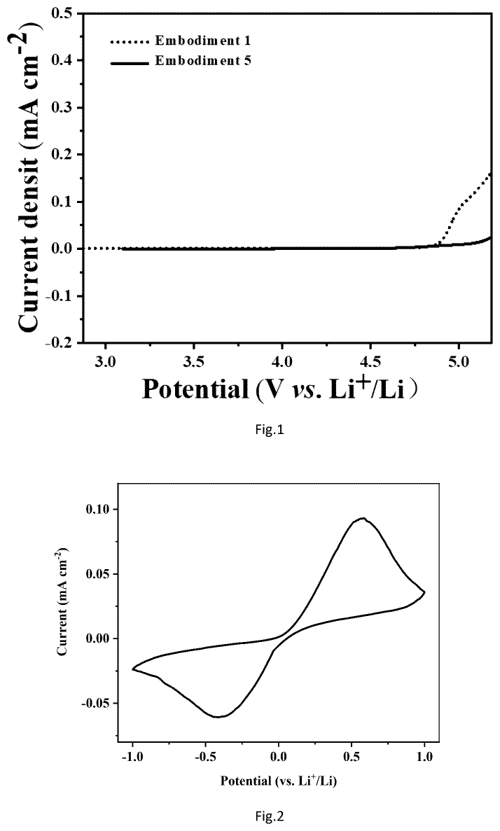

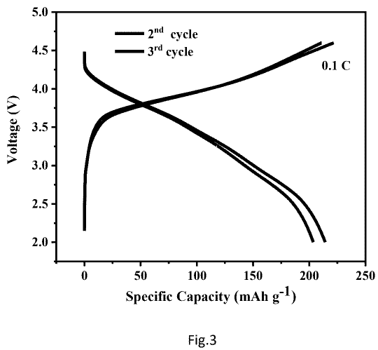

### PREFERRED EMBODIMENTS

The present invention is described below by means of preferred embodiments, which are provided for a better understanding of the present invention and are by no means intended to limit the scope of the present invention.

### Preparation of Electrolyte:

### Embodiment 1

Added 50 mg of lithium lanthanum zirconium tantalum oxide inorganic ion conductor (LLZTO) with hydroxyl groups on the surface and 150 mg of 3-aminopropyltriethoxysilane (APTES) to 2 mL acetonitrile and stirred to obtain a mixed solution A1. After ultrasonic treatment for 30 minutes, the solution was stirred at 60° C. for 24 hours. The solution was then transferred to a vacuum drying oven at 80° C. to remove the solvent to obtain an APTES@LLZTO white powder 1. Then 1 g of vinyl ethylene carbonate and 0.3 g of lithium bistrifluoromethanesulfonyl imide (LiTFSI) were mixed and stirred to obtain a solution A2. The above-mentioned APTES@LLZTO powder 1 (2 wt %) was mixed with the A2 solution and 1% of the mass of the A2 solution, and the solution was ultrasonicated at room temperature for 30 minutes and then stirred for 4 hours to obtain an electrolyte mixture. On a polytetrafluoroethylene mold, with a Whatman glass fiber membrane as a porous support skeleton, the evenly stirred electrolyte mixture is scraped onto both sides of the Whatman membrane; it is heated at 80° C. in a vacuum drying oven for 10 hours to solidify into an organic-inorganic composite electrolyte membrane with an average thickness of ˜140 μm.

### Embodiment 2

Added 200 mg of lithium lanthanum zirconium tantalum oxide inorganic ion conductor (LLZTO) with hydroxyl groups on the surface and 200 mg of 3-aminopropyltriethoxysilane (APTES) to 4 mL acetonitrile and stirred to obtain a mixed solution B1. After ultrasonic treatment for 30 minutes, the solution was stirred at 60° C. for 24 hours. The solution was then transferred to a vacuum drying oven at 80° C. to remove the solvent to obtain an APTES@LLZTO white powder 2. Then 1 g of vinyl ethylene carbonate and 0.3 g of lithium bistrifluoromethanesulfonyl imide (LiTFSI) were mixed and stirred to obtain a solution B2. The above-mentioned APTES@LLZTO powder 2 (4 wt %) was mixed with B2 solution and 1% of azobisisobutyronitrile (AIBN) by mass of B2 solution. The solution was ultrasonicated at room temperature for 30 minutes and then stirred for 4 hours to obtain an electrolyte mixture. On a polytetrafluoroethylene mold, with a Whatman glass fiber membrane as a porous support skeleton, the evenly stirred electrolyte mixture was scraped onto both sides of the Whatman membrane; it was heated at 80° C. in a vacuum drying oven for 10 hours to solidify into an organic-inorganic composite electrolyte membrane with an average thickness of ˜143 μm.

### Embodiment 3

Added 100 mg of lithium lanthanum tantalum oxide inorganic ion conductor (LLTO) with hydroxyl groups on the surface and 100 mg of 3-aminopropyltriethoxysilane (APTES) to 2 mL acetonitrile and stirred to obtain a mixed solution C1. After ultrasonic treatment for 30 minutes, the solution was stirred at 60° C. for 24 hours. The solution was then transferred to a vacuum drying oven at 80° C. to remove the solvent to obtain an APTES@LLTO white powder 3. Then 1 g of vinyl ethylene carbonate and 0.3 g of lithium bis(trifluoromethanesulfonyl)imide (LiClO₄) were mixed and stirred to obtain a solution C2. The above-mentioned APTES@LLTO powder 3 (2 wt %) was mixed with the C2 solution and 1% of the mass of the C2 solution, and the solution was ultrasonicated at room temperature for 30 minutes and then stirred for 4 hours to obtain an electrolyte mixture. On a polytetrafluoroethylene mold, with a Whatman glass fiber membrane as a porous support skeleton, the evenly stirred electrolyte mixture was scraped onto both sides of the Whatman membrane; it was heated at 80° C. in a vacuum drying oven for 10 hours to solidify into an organic-inorganic composite electrolyte membrane with an average thickness of ˜142 μm.

### Embodiment 4

Added 100 mg of lithium lanthanum zirconium tantalum oxide inorganic ion conductor (LLZTO) with hydroxyl groups on the surface and 200 mg of 3-aminopropyltriethoxysilane (APTES) to 2 mL acetonitrile and stirred to obtain a mixed solution D1. After ultrasonic treatment for 30 minutes, the solution was stirred at 60° C. for 24 hours. The solution was then transferred to a vacuum drying oven at 80° C. to remove the solvent, and an APTES@LLZTO white powder 4 was obtained. Then 1 g of vinyl ethylene carbonate and 0.3 g of lithium bistrifluoromethanesulfonyl imide (LiTFSI) were mixed and stirred to obtain a solution D2. The above-mentioned APTES@LLZTO powder (2 wt %) was mixed with the D2 solution and 1% of azobisisobutyronitrile (AIBN) by mass of the D2 solution. The solution was ultrasonicated at room temperature for 30 minutes and then stirred for 4 hours to obtain an electrolyte mixture. On a polytetrafluoroethylene mold, with a Whatman glass fiber membrane as a porous support skeleton, the evenly stirred electrolyte mixture was scraped onto both sides of the Whatman membrane; it was heated at 80° C. in a vacuum drying oven for 10 hours to solidify into an organic-inorganic composite electrolyte membrane with an average thickness of ˜141 μm.

### Embodiment 5

Added 100 mg of lithium lanthanum zirconium tantalum oxide inorganic ion conductor (LLZTO) with hydroxyl groups on the surface and 100 mg of 3-aminopropyltriethoxysilane (APTES) to 2 mL of acetonitrile and stirred to obtain a mixed solution E1. After ultrasonic treatment for 30 minutes, the solution was stirred at 60° C. for 24 hours. The solution was then transferred to a vacuum drying oven at 80° C. to remove the solvent, and an APTES@LLZTO white powder 5 was obtained. Then 1 g of vinyl ethylene carbonate and 0.3 g of lithium bis(trifluoromethanesulfonyl)imide (LiTFSI) were mixed and stirred to obtain a solution E2. The above-mentioned APTES@LLZTO powder 5 (8 wt %) was mixed with the E2 solution and 1% of azobisisobutyronitrile (AIBN) by mass of the E2 solution. The solution was ultrasonicated at room temperature for 30 minutes and then stirred for 4 hours to obtain an electrolyte mixture. On a polytetrafluoroethylene mold, with a Whatman glass fiber membrane as a porous support skeleton, the evenly stirred electrolyte mixture is scraped onto both sides of the Whatman membrane; it is heated at 80° C. in a vacuum drying oven for 10 hours to solidify into an organic-inorganic composite electrolyte membrane with an average thickness of ˜146 μm.

### Embodiment 6

Added 100 mg of lithium lanthanum zirconium tantalum oxide inorganic ion conductor (LLZTO) with hydroxyl groups on the surface and 50 mg of 3-aminopropyltriethoxysilane (APTES) to 2 mL of acetonitrile and stirred to obtain a mixed solution F1. After ultrasonic treatment for 30 minutes, the solution was stirred at 60° C. for 24 hours. The solution was then transferred to a vacuum drying oven at 80° C. to remove the solvent, and an APTES@LLZTO white powder 6 was obtained. Then 1 g of vinyl ethylene carbonate and 0.3 g of lithium bistrifluoromethanesulfonyl imide (LiTFSI) were mixed and stirred to obtain a solution F2. The above-mentioned APTES@LLZTO powder 6 (4 wt %) was mixed with the F2 solution and 1% of the mass of the F2 solution, and the solution was ultrasonicated at room temperature for 30 minutes and then stirred for 4 hours to obtain an electrolyte mixture. On a polytetrafluoroethylene mold, with a Whatman glass fiber membrane as a porous support skeleton, the evenly stirred electrolyte mixture was scraped onto both sides of the Whatman membrane; it was heated at 80° C. in a vacuum drying oven for 10 hours to solidify into an organic-inorganic composite electrolyte membrane with an average thickness of ˜143 μm.

Electrolyte thickness: the thickness of the block polymer electrolyte was measured using a micrometer (accuracy 0.01 mm), and the thickness was measured at 3 random points on the membrane to calculate the average value.

Ionic conductivity: the polymer electrolyte was sandwiched between two stainless steel gaskets and the R2032 button cell was assembled to measure impedance according to the formula

$$σ = \frac{L}{SR} ,$$

where L is the thickness of the polymer electrolyte, S is the area of the stainless steel gasket, and R is the measured impedance value.

Electrochemical window: A 2032 button cell was assembled by sandwiching the polymer electrolyte with stainless steel and lithium sheets, and linear voltammetry (LSV) measurements were performed with a starting voltage of 2.8V, a maximum potential of 5.5 V, and a scan rate of 1 m V/S.

### Embodiment 7

240 mg of lithium-rich manganese-based layered oxide positive electrode and 45 mg of conductive agent acetylene black were uniformly ground for 40 minutes; 15 mg of binder polyvinylidene fluoride, 15 mg of electrolyte mixture (Embodiment 5) and 150 μL of 1-methyl-2-pyrrolidone were added and uniformly ground for 40 minutes; coated on the surface of aluminum foil and dried at 80° C. for 8 hours under vacuum conditions; the pole piece was cut into a disc with R=12 mm, and the organic-inorganic composite electrolyte of Example 5 above was used as the electrolyte and metallic lithium was used as the negative electrode to assemble a solid-state lithium-ion battery.

### Embodiment 8

240 mg of lithium cobalt oxide positive electrode and 45 mg of conductive agent acetylene black were uniformly ground for 40 minutes; 15 mg of binder polyvinylidene fluoride, 15 mg of electrolyte mixture (Embodiment 5) and 150 μL of 1-methyl-2-pyrrolidone were added and uniformly ground for 40 minutes; coated on the surface of aluminum foil and dried at 80° C. for 8 hours under vacuum conditions; the pole piece was cut into a disc with R=12 mm, and the organic-inorganic composite electrolyte of Example 5 above was used as the electrolyte and metallic lithium was used as the negative electrode to assemble a solid-state lithium-ion battery.

TABLE 1

| | ionic conductivity | Electrochemical |
|---|---|---|
| Embodiment | (S/cm, 25° C.) | window (vs. Li⁺/Li) |
| 1 | 1.9 × 10⁻³ | 4.8 |
| 2 | 2.6 × 10⁻³ | 5.1 |
| 3 | 2.3 × 10⁻³ | 4.8 |
| 4 | 2.0 × 10⁻³ | 4.8 |
| 5 | 3.1 × 10⁻³ | 5.0 |
| 6 | 1.95 × 10⁻³ | 5.3 |

What is claimed is:

1. A high ionic conductivity polymer-based composite solid electrolyte, characterized in that the raw materials of which include the following components: carbonate-based polymer, inorganic ion conductor, initiator or catalyst, lithium salt and silane coupling agent;
the mass fraction of the carbonate-based polymer in the mixture is 10%-96%, the mass fraction of the functionalized silane coupling agent in the mixture is 1%-50%, the mass fraction of the conductive lithium salt in the mixture is 1%-50%, the mass fraction of the inorganic ion conductor in the mixture is 1%-50%, and the mass fraction of the initiator or catalyst in the mixture is 1%-10%;
the carbonate-based polymer is one or more selected from the group consisting of polycarbonate, polyvinyl carbonate, polyvinyl ethylene carbonate, polyallyl methyl carbonate, polyvinylene carbonate, polyfluoroethylene carbonate and the like. The C═O double bond in the carbonate group can form a chemical interaction with the active H on the silane coupling agent;
the inorganic lithium-ion conductor material is an inorganic solid lithium-ion electrolyte, and the material contains one or a combination of at least two of hydroxyl, carboxyl or sulfur groups;
the silane coupling agent has a structure as shown in formula I: 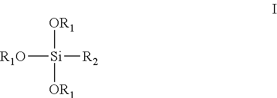
wherein R₁ is selected from any one of methyl, ethyl, and propyl; R₂ is selected from any one of aminopropyl, aminoethyl, mercapto, or urea.

2. A high ionic conductivity polymer-based composite solid electrolyte according to claim 1, characterized in that the selected conductive lithium salt is one or more of the following: lithium hexafluorophosphate (LiPF₆), lithium perchlorate LiClO₄), lithium bis(LiTFSI)imide (LiTFSI), and bis(trifluoromethanesulfonyl)methyl lithium [LiC(SO₂CF₃)₃];
the initiator or catalyst is one of the following: azobisisobutyronitrile (AIBN), azobisisoheptanenitrile (ABVN), dibutyltin bis (acetylacetonate), dibutyltin dilaurate, dimethyl azobisisobutyrate (AIBME), benzoyl peroxide (BPO), platinum water (Pt).

3. The method for preparing a high ionic conductivity organic-inorganic composite solid electrolyte according to claim 1, characterized in that it comprises the following steps:
(1) taking an inorganic ion conductor material, a functionalized silane coupling agent, and an organic solvent raw material, stirring and mixing them uniformly, heating and hydrolyzing them at 30° C.-80° C. (reagents and trace water in the air are sufficient) for 12-24 hours, and then removing the solvent in a vacuum drying oven at 80° C.-120° C. to prepare a silanized inorganic ion conductor material;
(2) uniformly stirring the silanized inorganic ion conductor material, carbonate-based polymer, conductive lithium salt, and organic solvent obtained in step (1); adding an initiator or a catalyst and uniformly stirring to form an electrolyte mixture; coating or immersing the electrolyte mixture into a polytetrafluoroethylene mold containing a porous support material, and heating and curing at 60° C.-120° C. for 4-12 hours to form a film.

4. The method for preparing a high ionic conductivity organic-inorganic composite solid electrolyte according to claim 3, characterized in that the organic solvent selected in the above steps (1) and (2) is one or more of the following: N-methylpyrrolidone (NMP), ethylene carbonate, propylene carbonate, butylene carbonate, dimethyl carbonate, ethylene carbonate, ethyl methyl carbonate, γ-butyrolactone, tetrahydrofuran, 2-methyltetrahydrofuran, acetonitrile, 1,2-dimethoxyethane, tetraethylene glycol dimethyl ether, triethylene glycol dimethyl ether, diethylene glycol dimethyl ether, and dimethyl sulfoxide.

5. The method for preparing a high ionic conductivity organic-inorganic composite solid electrolyte according to claim 3, characterized in that the porous supporting material is one or more of cellulose non-woven fabric, polyethylene non-woven fabric, polypropylene non-woven fabric, glass fiber non-woven fabric, and polytetrafluoroethylene non-woven fabric; preferred supporting materials can improve the mechanical properties of polymer-based composite electrolytes.

6. The method for preparing a high ionic conductivity organic-inorganic composite solid electrolyte according to claim 3, characterized in that coupling agents serve as bridges between inorganic and organic matter to provide additional ion transport channels and reduce the interface resistance between organic and inorganic substances;
they utilize intermolecular interactions and stable chemical bonds to improve the electrochemical stability of polymer-based composite electrolytes. Intermolecular interactions include positive vacancy effects, dipole-dipole interactions, and hydrogen bond interactions.

7. Application of the high ionic conductivity polymer-based composite solid electrolyte according to claim 1 in lithium-ion batteries.

8. A solid-state lithium-ion battery comprising the above-mentioned high ionic conductivity polymer-based composite solid electrolyte, characterized in that it comprises a positive electrode, a negative electrode and the above-mentioned composite solid electrolyte placed between the positive electrode and the negative electrode and having the functions of both a separator and an electrolyte, wherein the composite solid electrolyte is the high ionic conductivity polymer-based composite solid electrolyte according to claim 1.

9. The lithium-ion battery according to claim 8, characterized in that the positive electrode active material of the lithium-ion battery is one or more of lithium cobalt oxide (LiCoO₂), lithium nickel oxide LiNiO₂), lithium ion lithium fluorophosphate, lithium manganese oxide, lithium manganese oxide, lithium nickel manganese oxide, lithium rich materials (LLOs), lithium iron manganese phosphate, lithium nickel cobalt aluminum oxide (NCA), lithium nickel cobalt manganese oxide, lithium iron phosphate (LiFeO₄), and lithium vanadium phosphate (Li₃V₂(PO₄)₃); the negative electrode active material is one or more of metallic lithium, metallic lithium alloy, graphite, hard carbon, lithium metal nitride, antimony oxide, carbon germanium composite material, carbon silicon composite material, lithium titanate, and lithium titanium oxide;
the preparation of the positive electrode of a lithium-ion battery includes the following steps: grinding and mixing a positive electrode active material accounting for 50%-90% by mass and a conductive agent acetylene black accounting for 5%-30% by mass; adding polyvinylidene fluoride (PVDF) accounting for 1%-15% by mass, 1%-15% electrolyte mixed solution and 1-methyl-2-pyrrolidone (NMP) to grind and mix, and 1-methyl-2-pyrrolidone (NMP) is used to adjust the viscosity; coating on the surface of aluminum foil and drying; metallic lithium and metallic lithium alloy can be directly used as the corresponding negative electrode. The preparation of other negative electrodes includes the following steps: grinding and mixing a negative electrode active material accounting for 45%-80% by mass and a conductive agent acetylene black accounting for 5%-30% by mass; adding polyvinylidene fluoride (PVDF) accounting for 5%-25% by mass and 1-methyl-2-pyrrolidone (NMP) to grind and mix, and 1-methyl-2-pyrrolidone (NMP) is used to adjust the viscosity; coating on the surface of copper foil and drying; wherein
the above-mentioned electrolyte mixture is the electrolyte mixture formed during the preparation process of the high ion conductivity organic-inorganic composite solid electrolyte according to claim 3.

10. The lithium-ion battery according to claim 8 is characterized in that the lithium-ion battery assembly includes a button battery and a soft-pack battery.
